(19) United States
(12) Patent Application Publication
(10) Pub. No.: US 2004/0015645 A1
(43) Pub. Date: Jan. 22, 2004

(54) System, apparatus, and method for a flexible DRAM architecture

(76) Inventors: James M. Dodd, Shingle Springs, CA (US); Brian P. Johnson, Folsom, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/199,578

(22) Filed: Jul. 19, 2002

(51) Int. Cl. G06F 12/00

(52) U.S. Cl. 711/5; 711/220; 711/105

(57) ABSTRACT

An addressing scheme to allow for a flexible DRAM configuration.

### BACKGROUND OF THE CLAIMED SUBJECT MATTER

1. Field of the Claimed Subject Matter

The claimed subject matter relates to dynamic random access memory architectures.

2. Description of the Related Art

A Dynamic Random Access Memory, DRAM, is a typical memory to store information. DRAMs contain a memory cell array having a plurality of individual memory cells; each memory cell is coupled to one of a plurality of sense amplifiers, bit lines, and word lines. The memory cell array is arranged as a matrix of rows and columns, and the matrix is further subdivided into a number of banks.

A memory controller requests data information from the DRAM by forwarding three addresses, one each for a bank, row, and column. The memory controller is dependent on the individual DRAM architecture because the memory controller needs to explicitly indicate which bank is accessed and which row and page is active in each bank. Thus, future DRAM architectures require extensive changes in the memory controller design.

### BRIEF DESCRIPTION OF THE DRAWINGS

Subject matter is particularly pointed out and distinctly claimed in the concluding portion of the specification. The claimed subject matter, however, both as to organization and method of operation, together with objects, features, and advantages thereof, may best be understood by reference to the following detailed description when read with the accompanying drawings in which:

FIG. 1 is a schematic diagram in accordance with one embodiment.

FIG. 2 is a flowchart of a method in accordance with one embodiment.

FIG. 3 is a system in accordance with one embodiment.

### DETAILED DESCRIPTION

In the following description, for purposes of explanation, numerous details are set forth in order to provide a thorough understanding of the claimed subject matter. However, it will be apparent to one skilled in the art that these specific details are not required in order to practice the claimed subject matter.

An area of current technological development relates to optimizing DRAM architectures to allow for compatibility with a variety of memory controller designs. As previously described, prior art memory controller and DRAM architectures utilize three address fields. However, the prior art DRAM architectures preclude migration for different bank and row configurations because of incompatibility with the existing memory controller designs. In contrast, a memory controller that is independent from the DRAM architecture results in optimizing DRAM and memory controller designs for a specific application and facilitating a transition to new and future DRAM architectures while supporting old and existing memory controller architectures. Therefore, a single DRAM component type would be compatible with a variety of memory controller architectures.

In one aspect, the claimed subject matter establishes a DRAM architecture to allow the number of supported banks to be transparent to the memory controller. In another aspect, the claimed subject matter increases the flexibility of DRAM and memory controller architectures by including an auxiliary address field that is based at least in part on the functional capability of the DRAM and memory controller. In yet another aspect, the claimed subject matter facilitates an overlap mapping of bank and row addresses.

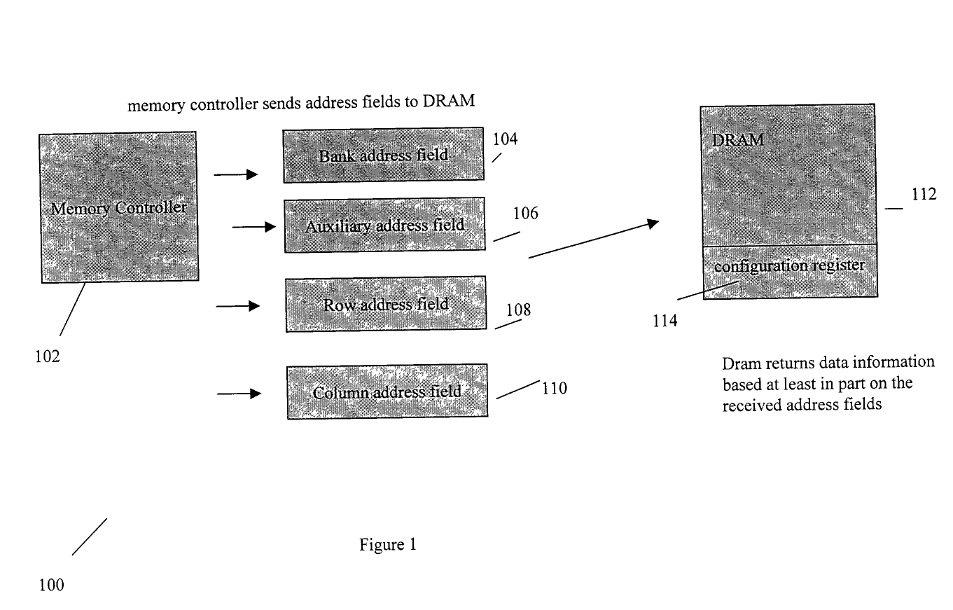

FIG. 1 is a schematic diagram 100 in accordance with one embodiment. The schematic 100 includes, but is not limited to, a memory controller 102 and a DRAM 112. The memory controller 102 requests data information from the DRAM by forwarding four address fields: a bank address field 104, an auxiliary address field 106, a row address field 108, and a column address field 110.

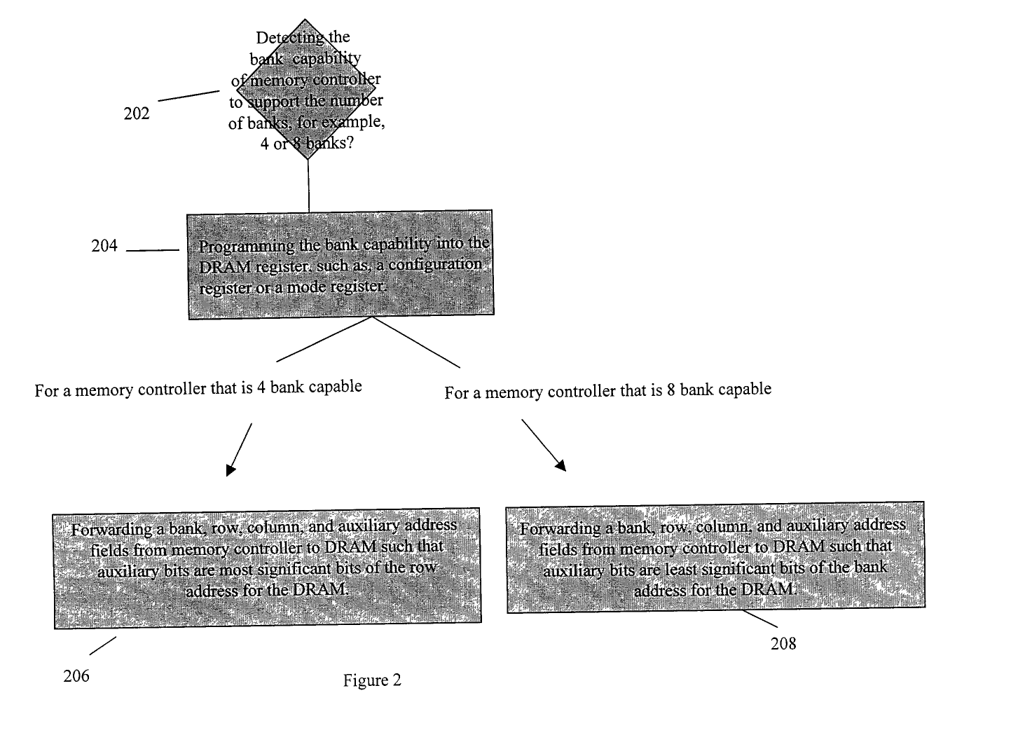

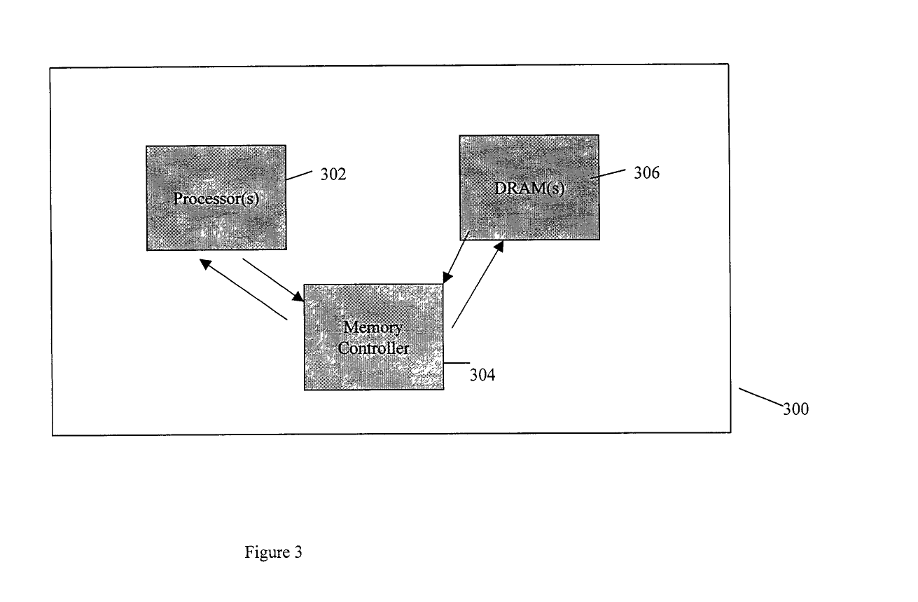

In one embodiment, the DRAM supports the conventional address scheme, however, the DRAM further includes supporting the use of the auxiliary address field. Likewise, the utilization of the auxiliary address field is based at least in part on the functional capability of the DRAM and memory controller. For example, the auxiliary address field can be used as either bank or row address to support different DRAM bank configurations, which is illustrated in the next few paragraphs and in connection with FIGS. 2 and 3.

For example, a DRAM with a storage capability of 256 million bits (Mb) would have an address mapping of two bits for the bank address field, one bit for the auxiliary address field, twelve for the row address field, and ten bits for the column address field. However, if a particular application requires a different configuration of the 256 Mb to have a different number of banks or rows, the prior art memory controller could not support the different configuration. In contrast, the schematic 100 allows for flexibility by interpreting the auxiliary address field by adjusting to the different configuration. For example, the bank address is the combination of the auxiliary address field bits and the bank address field bits for supporting a configuration with an increase in banks. In contrast, the row address is the combination of the auxiliary address field bits and the row address field bits for supporting a configuration with an increase in rows. In one embodiment, the auxiliary address field is the least significant bits of the bank address. In another embodiment, the auxiliary address field is the most significant bits of the row address. In one embodiment, the DRAM is programmed via a configuration register 114 to indicate the memory controller's use of the auxiliary address field bits. There are no special latching or sampling requirements for the auxiliary address field since it is latched at the same time as the row and column address field, which is well known in the art. In one embodiment, the memory controller interprets the auxiliary address field bits as the least significant bits of the bank address for a bank activate.

However, the claimed subject matter is not limited to the auxiliary address field representing the least significant bits of the bank address or the most significant bits of the row address. For example, the auxiliary address field bits could represent the least significant bits of the row address or the most significant bits of the bank address. Another example, the auxiliary address field bits could represent a specified range within a bank or row address, such as, bits 3:4 for two auxiliary address bits.

FIG. 2 is a flowchart of a method in accordance with one embodiment. The flowchart comprises a plurality of diamonds and blocks 202, 204, 206, and 208. In one embodiment, the method depicts establishing a transparency from a memory controller's perspective as to the number of supported banks within a DRAM.

Detecting the bank capability of memory controller to support the number of banks, as illustrated by the diamond 202. For example, the number of banks detected is either four or eight banks. Programming the bank capability into the DRAM register, as illustrated by the block 204. For example, the DRAM register is a configuration register or a mode register. If the memory controller has a four-bank capability, then forwarding a plurality of bank, row, column, and auxiliary address fields from memory controller to DRAM such that auxiliary bits are most significant bits of the row address for the DRAM, as illustrated by block 206. However, if the memory controller has a eight bank capability, then forwarding a plurality of bank, row, column, and auxiliary address fields from memory controller to DRAM such that auxiliary bits are the least significant bits of the bank address for the DRAM, as illustrated by block 208.

However, the claimed subject matter is not limited to detecting four or eight bank capability. For example, the flowchart supports various permutations of bank capability to include two, sixteen, etc . . .

In one embodiment, the blocks 206 and 208 will preclude the memory controller from forwarding the auxiliary address field bits for conditions, such as, a precharge or a read and write command.

FIG. 3 depicts a system in accordance with one embodiment. The system 300 comprises a processor 302, a memory controller 304, and a DRAM 306. In one embodiment, the system 300 is a single processor system. In an alternative embodiment, the system comprises multiple processors 302. The processor decodes and executes instructions and requests data and directory information from the DRAM 306 via the memory controller 304.

In one embodiment, the system is a computer. In another embodiment, the system is a computing system, such as, a personal digital assistant (PDA), communication device, or Internet tablet. In one embodiment, the DRAM is a synchronous dynamic random access memory (SDRAM).

In one embodiment, the memory controller is an integrated device. In an alternative embodiment, a chipset includes the memory controller. The DRAM 306 supports the address protocol depicted in connection with FIG. 1 and the flowchart for establishing a transparency from a memory controller's perspective as to the number of supported banks depicted in connection with FIG. 2.

Although the claimed subject matter has been described with reference to specific embodiments, this description is not meant to be construed in a limiting sense. Various modifications of the disclosed embodiment, as well as alternative embodiments of the claimed subject matter, will become apparent to persons skilled in the art upon reference to the description of the claimed subject matter. It is contemplated, therefore, that such modifications can be made without departing from the spirit or scope of the claimed subject matter as defined in the appended claims.

1. A method for addressing a dynamic random access memory (DRAM) with a plurality of rows, columns, and banks comprising:
forwarding at least one address field to the DRAM to allow for an overlap mapping of a bank address and a row address based at least in part on a functional capability of the DRAM; and
addressing the DRAM based at least in part on an auxiliary address field.

2. The method of claim 1 wherein a memory controller forwards the auxiliary address field, a bank address field, a row address field, and a column address field.

3. The method of claim 1 wherein the DRAM supports a plurality of memory controller architectures by dynamically interpreting the auxiliary address field, such that, the auxiliary address field is to be combined with the bank address field to form a bank address for the DRAM when increasing the number of banks supported by the DRAM.

4. The method of claim 1 wherein the DRAM supports a plurality of memory controller architectures by dynamically interpreting the auxiliary address field, such that, the auxiliary address field is to be combined with the row address field to form a row address for the DRAM when increasing the number of rows supported by the DRAM.

5. The method of claim 1 wherein the number of banks supported by the DRAM is transparent to a memory controller.

6. The method of claim 1 wherein the DRAM includes a configuration register that is programmed to indicate a memory controller's interpretation of the auxiliary address field.

7. An apparatus to address a dynamic random access memory (DRAM) with a plurality of rows, columns, and banks comprising:
a memory controller to forward a plurality of address fields, with an auxiliary address field, to allow for an overlap mapping of a bank address and a row address based at least in part on a functional capability of the DRAM; and
the DRAM to include a configuration register that is programmed to indicate a memory controller's interpretation of the auxiliary address field.

8. The apparatus of claim 7 wherein the memory controller forwards the plurality of address fields including at least the auxiliary address field, a bank address field, a row address field, and a column address field.

9. The apparatus of claim 7 wherein the DRAM supports a plurality of memory controller architectures by dynamically interpreting the auxiliary address field, such that, the auxiliary address field is to be combined with the bank address field to form a bank address for the DRAM when increasing the number of banks supported by the DRAM.

10. The apparatus of claim 7 wherein the DRAM supports a plurality of memory controller architectures by dynamically interpreting the auxiliary address field, such that, the auxiliary address field is to be combined with the row address field to form a row address for the DRAM when increasing the number of rows supported by the DRAM.

11. The apparatus of claim 7 wherein the number of banks supported by the DRAM is transparent to the memory controller.

12. A method for an agent addressing a dynamic random access memory (DRAM) with a plurality of rows, columns, and banks comprising:
detecting a bank capability of the agent;
programming the bank capability into the DRAM; and
interpreting an auxiliary address field based at least in part on the bank capability.

13. The method of claim 12 wherein the agent is a memory controller.

14. The method of claim 12 wherein the bank capability of the agent is either four or eight.

15. The method of claim 12 wherein the DRAM supports a plurality of memory controller architectures by dynamically interpreting the auxiliary address field, such that, the auxiliary address field is to be combined with the row address field to form a row address for the DRAM when increasing the number of rows supported by the DRAM.

16. The method of claim 12 wherein the DRAM supports a plurality of memory controller architectures by dynamically interpreting the auxiliary address field, such that, the auxiliary address field is to be combined with the bank address field to form a bank address for the DRAM when increasing the number of banks supported by the DRAM.

17. A system comprising:
at least one processor, coupled to a memory controller, to issue requests for data information from at least one dynamic random access memory(DRAM); and
the memory controller to forward a plurality of address fields, with an auxiliary address field, to the DRAM, wherein a bank capability of the DRAM is transparent to the memory controller.

18. The system of claim 17 wherein the memory controller forwards the auxiliary address field, a bank address field, a row address field, and a column address field.

19. The system of claim 17 wherein the DRAM includes a configuration register that is programmed to indicate a memory controller's interpretation of the auxiliary address field.

20. The system of claim 17 wherein the DRAM is a synchronous dynamic random access memory (SDRAM).
